(19) United States
(12) Patent Application Publication
(10) Pub. No.: US 2024/0272010 A1
(43) Pub. Date: Aug. 15, 2024

(54) TEMPERATURE SENSOR

(71) Applicant: ROHM CO., LTD., KYOTO (JP)

(72) Inventor: Yoshito OTAGURO, KYOTO (JP)

(21) Appl. No.: 18/429,908

(22) Filed: Feb. 1, 2024

(30) Foreign Application Priority Data
Feb. 14, 2023 (JP) 2023-020837

(51) Int. Cl. G01K 7/01

(52) U.S. Cl. CPC G01K 7/01

(57) ABSTRACT

The present disclosure provides a temperature sensor. The temperature sensor includes: a temperature detection diode, disposed at a position having a target temperature; a current supply circuit, configured to supply a first evaluation current and a second evaluation current to the temperature detection diode in a forward direction of the temperature detection diode at different timings; an amplifying circuit, configured to generate a first amplified voltage and a second amplified voltage by amplifying a difference between a forward voltage of the temperature detection diode and a reference voltage when the first and second evaluation currents are supplied to the temperature detection diode; a temperature detection circuit, configured to detect the target temperature based on the first and second amplified voltages; and a reference voltage generation circuit, configured to include a reference diode disposed at a position having a temperature corresponding to the target temperature.

### TECHNICAL FIELD

The present disclosure relates to a temperature sensor.

### BACKGROUND

Temperature sensors performing temperature detection by using PN junction diodes are extensively used.

### PRIOR ART DOCUMENT

### Patent Publication

[Patent document 1] Japan Patent Publication No. 2012-227517

### BRIEF DESCRIPTION OF THE DRAWINGS

FIG. 1 is a diagram of a current and a voltage associated with a diode according to the embodiment of the present disclosure.

FIG. 2 is a configuration diagram of a temperature sensor according to an embodiment of the present disclosure.

FIG. 3 is a flowchart of an operation of a temperature sensor according to an embodiment of the present disclosure.

FIG. 4 is a diagram of a temperature dependency of an operation value associated with temperature detection according to an embodiment of the present disclosure.

FIG. 5 is a diagram of relationships between a forward current and a forward voltage of a diode according to the embodiment of the present disclosure.

FIG. 6 is a diagram of a bipolar transistor forming a diode according to a fourth embodiment of the embodiments of the present disclosure.

FIG. 7 is a configuration diagram of a sensor device including a temperature sensor therein according to a fifth embodiment of the present disclosure.

FIG. 8 is a variation configuration diagram of a temperature sensor according to a sixth embodiment of the present disclosure.

FIG. 9 is a perspective diagram of the appearance of a semiconductor device assembled with a temperature sensor according to the sixth embodiment of the disclosure.

### DETAILED DESCRIPTION OF THE EMBODIMENTS

Details of examples of the embodiments of the present invention are given with the accompanying drawings below. In the reference drawings, the same parts are denoted by the same numerals or symbols, and repeated description related to the same parts is in principle omitted. Moreover, in the present application, in order to keep the description simple, by means of recording numerals or symbols of reference information, signals, physical quantities, functional units, circuits, elements or parts, names of information, signals, physical quantities, functional units, circuits, elements or parts corresponding to the numerals or symbols are sometimes omitted or abbreviated.

Some terms and definitions of arrangements used in the description of the embodiments of the present disclosure are first explained below. The so-called “ground” refers to a reference conductive unit having a reference voltage of 0 V potential or the 0 V potential itself. The reference conductive unit may be a conductor formed of such as metal. The 0 V potential is sometimes referred to as a ground potential. In the embodiments of the present disclosure, a voltage expressed without a specifically configured reference represents a potential from a ground aspect.

MOSFET is an abbreviation of metal-oxide-semiconductor field-effect transistor. Unless otherwise specified, a MOSFET is understood as an enhanced MOSFET. Moreover, unless otherwise specified, any in MOSFET, it is considered that the back gate is shorted to the source.

More than one FET can be configured as any switch, two terminals of the switch are conducted when the switch is in an on state, and on the other hand, the two terminals of the switch are non-conducted when the switch is in an off state.

In the description below, for any transistor or switch, the on state and the off state are sometimes expressed simply as on and off. Moreover, for any transistor or switch, a period in which the transistor or the switch becomes in an on state is referred to an on period, and a period in which the transistor or the switch is changed to being in an off state is referred to as an off period.

A connection formed between multiple parts of a circuit, such as elements, wires and nodes that form a circuit, can be understood as an electrical connection unless otherwise specified.

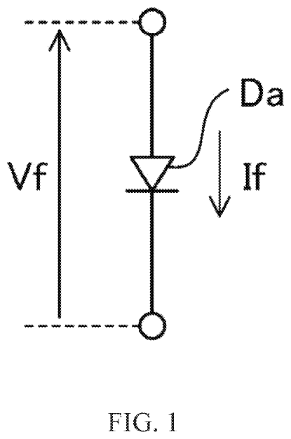

Referring to FIG. 1, a temperature detection method using a diode temperature sensor is described below. A temperature to be detected (in other words, measured) by the temperature sensor is referred to as a target temperature.

A diode D1 is a diode formed by a PN junction of a semiconductor. The denotation “If” is used to represent a forward current of the diode D1. When the forward current If is supplied to the diode D1, the denotation “Vf” is used to represent a forward voltage generated in the diode D1. According to the Shockley diode equation, formula (A1) below holds true.

$$V f = ( {K}_{B} / q ) \times {T}_{D} \times ln ( If / Is ) \qquad ( A1 )$$

Herein, KB represents the Boltzmann constant, and q represents an amount of charge of electrons. Thus, (KB/q) has a fixed value. T_{D} represents a temperature of the diode D1 (a temperature that the diode D1 has). The diode D1 is disposed at a position having the target temperature. Thus, the temperature T_{D} is equal to the target temperature. The denotation “Is” is used to represent a saturation current of the diode D1. Moreover, in the formulae show in the present application, ln(x) represents a natural logarithm of x. Thus, for example, ln(If/Is) in formula (A1) represents the natural logarithm of (If/Is).

The saturation current Is has a constant value determined basically depending on the type of the diode D1. Thus, the temperature T_{D} (that is, the target temperature) can be detected by detecting the forward voltage Vf when the known forward current If is supplied to the diode D1.

However, the saturation current Is may be deviated due to manufacturing errors of the diode D1. Considering the above, a reference method for detecting voltages Vf1 and Vf2 satisfying formulae (A2) and (A3) below and obtaining a voltage ΔVf based on the voltages Vf1 and Vf2 according to formula (A4) is discussed.

$$V f 1 = ( {K}_{B} / q ) \times {T}_{D} \times ln ( If 1 / Is ) \qquad ( A1 )$$

$$V f 2 = ( {K}_{B} / q ) \times {T}_{D} \times ln ( If 2 / Is ) \qquad ( A1 )$$

$$ΔV f = V f 1 - V f 2 = ( {K}_{B} / q ) \times {T}_{D} \times ln ( If 1 / If 2 ) \qquad ( A4 )$$

The currents If1 and If2 represent forward currents If different from each other. The voltage Vf1 is a forward voltage Vf generated in the diode D1 by supplying the forward current If that satisfies “If=If1” to the diode D1. The voltage Vf2 is a forward voltage Vf generated in the diode D1 by supplying the forward current If that satisfies “If=If2” to the diode D1.

Formula (A4) is independent from the saturation current Is. Thus, by calculating the voltage ΔVf according to a difference between the voltages Vf1 and Vf2 and performing a calculation according to formula (A4), the temperature T_{D} can be obtained without influences of the deviation in the saturation current Is.

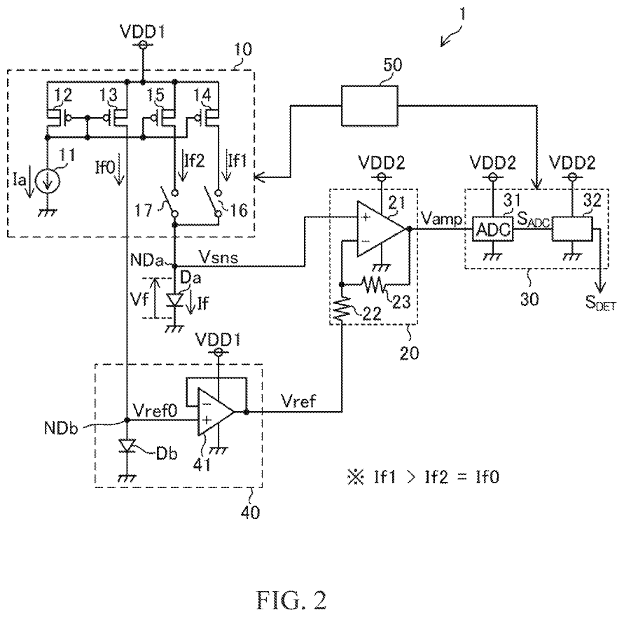

FIG. 2 shows a configuration diagram of a temperature sensor 1 according to this embodiment of the present disclosure. A temperature to be detected (in other words, measured) by the temperature sensor 1 is referred to as a target temperature. The temperature sensor 1 uses principles shown in formulae (A1) to (A4) to detect the target temperature. The temperature sensor 1 can be formed by a semiconductor integrated circuit.

The temperature sensor 1 includes a diode Da as a temperature detection diode, and uses the diode Da to detect (in other words, measure) the target temperature. The diode Da is disposed at a position having the target temperature. Thus, a temperature T_{D} of the diode Da is equal to the target temperature. In the temperature sensor 1, an anode of the diode Da is connected to a node NDa, and a cathode of the diode Da is connected to ground. In the temperature sensor 1, a forward current If refers to a forward current of the diode Da, unless otherwise specified.

In addition to the diode Da, the temperature sensor 1 further includes a current supply circuit 10, an amplifying circuit 20, a temperature detection circuit 30, a reference voltage generation circuit 40 and a control circuit 50.

The current supply circuit 10 supplies first and second evaluation currents to the diode Da at different timings. Each of the first and second evaluation currents is supplied in a forward direction of the diode Da. The denotation “If1” is used as a reference to refer the first evaluation current as an evaluation current If1. Similarly, the denotation “If2” is used as a reference to refer the second evaluation current as an evaluation current If2. The evaluation currents If1 and If2 have current values different from each other. When the evaluation currents If1 and If2 are supplied to the diode Da, each of the evaluation currents If1 and If2 is a forward current If of the diode Da.

The current supply circuit 10 includes a constant current source 11, transistors 12 to 15, and switches 16 and 17. The transistor 12 to 15 are P-channel MOSFETs. A source of each of the transistors 12 to 15 is connected to a terminal to which a power supply voltage VDD1 is applied. The power supply voltage VDD1 has a predetermined positive DC voltage value. A gate and a drain of the transistor 12 are commonly connected to respective gates of the transistor 13 to 15. The constant current source 11 is disposed between the drain of the transistor 12 and the ground. A drain of the transistor 13 is connected to a node NDb. A drain of the transistor 14 is connected to a first end of the switch 16, and a drain of the transistor 15 is connected to a first end of the switch 17. Respective second ends of the switches 16 and 17 are commonly connected to a node NDa.

The constant current source 11 generates a constant current Ia flowing from the drain of the transistor 12 to the ground. Thus, a drain current of the transistor 12 is the current Ia. The current Ia has a predetermined current value. The transistors 12 to 15 form a current mirror circuit. Thus, a drain current proportional to the current Ia flows through each of the transistors 13 to 15. The drain current of the transistor 13 is a reference current If0, the drain current of the transistor 14 is the evaluation current If1, and the drain current of the transistor 15 is the evaluation current If2.

However, if the flow of an instantaneous current is neglected, the drain current of the transistor 14 is generated only when the switch 16 is on, and the drain current of the transistor 15 is generated only when the switch 17 is on. Only one of the switches 16 and 17 is controlled to be on, or both of the switches 16 and 17 are controlled to be off by the control circuit 50.

During an on period of the switch 16, “If=If1”. The condition “If=If1” means that the evaluation current If1 flows as the forward current If of the diode Da. During an on period of the switch 17, “If=If2”. The condition “If=If2” means that the evaluation current If2 flows as the forward current If of the diode Da. By using the denotation “Vsns” as a reference, a voltage at the node NDa is referred to as a read voltage Vsns. The read voltage Vsns during an on period of the switch 16 is a forward voltage Vf of the diode Da when “If =If1”. The read voltage Vsns during an on period of the switch 17 is a forward voltage Vf of the diode Da when “If=If2”.

The read voltage Vsns is input to the amplifying circuit 20. Moreover, a reference voltage Vref from the reference voltage generation circuit 40 is also input to the amplifying circuit 20. The amplifying circuit 20 amplifies a difference between the read voltage Vsns and the reference voltage Vref, and outputs a voltage obtained by the amplification as an amplified voltage Vamp.

More specifically, the amplifying circuit 20 is a non-inverting amplifying circuit including an operational amplifier 21 and resistors 22 and 23. The operational amplifier 21 includes a non-inverting input terminal, an inverting input terminal and an output terminal. The non-inverting input terminal of the operational amplifier 21 is connected to the node NDa, and receives the read voltage Vsns. The reference voltage Vref is input to a first end of the resistor 22. A second end of the resistor 22 and a first end of the resistor 23 are commonly connected to the inverting input terminal of the operational amplifier 21. A second end of the resistor 23 is connected to the output terminal of the operational amplifier 21. The amplified voltage Vamp is applied to the output terminal of the operational amplifier 21. An amplification factor of the amplifying circuit 20 is set based on a ratio of resistances of the resistors 22 and 23. The denotation “A_{F}” is used to represent the amplification factor of the amplifying circuit 20. As such, the amplified voltage Vamp satisfying formula (B1) below is generated. The amplification factor A_{F} can be any value greater than 1.

$$V amp = ( V sns - V ref ) \times {A}_{F} + V ref \qquad ( B1 )$$

The operational amplifier 21 receives the supply of a power supply voltage VDD2, and performs driving based on the power supply voltage VDD2. The power supply voltage VDD2 has a predetermined positive DC voltage value. The power supply voltage VDD2 can be consistent with or different from the power supply voltage VDD1. The power supply voltage VDD2 is a power supply voltage with respect to a high potential side of the operational amplifier 21, and a power supply voltage on the low potential side of the operational amplifier 21 is 0 V. Thus, an output voltage (that is, the amplified voltage Vamp) of the operational amplifier 21 is a voltage greater than or equal to 0 V and less than or equal to the power supply voltage VDD2.

The temperature detection circuit 30 includes an analog-to-digital converter (ADC) 31 and an arithmetic circuit 32. The ADC 31 receives the amplified voltage Vamp output from the amplifying circuit 20 as an input analog voltage, and performs analog-to-digital (AD) conversion on the input analog voltage. In the AD conversion, the ADC 31 samples the input analog voltage at a timing specified by the control circuit 50, and converts the sampled input analog voltage into a digital signal. The ADC 31 outputs a digital signal SADC obtained from the AD conversion. The digital signal SADC has a digital value equivalent to a value of the sampled input analog voltage. The ADC 31 outputs the digital signal SADC to the arithmetic circuit 32.

The ADC 31 receives the supply of the power supply voltage VDD2, and performs driving based on the power supply voltage VDD2. The power supply voltage VDD2 is a power supply voltage with respect to a high potential side of the ADC 31, and a power supply voltage on the low potential side of the ADC 31 is 0 V. Thus, an input dynamic range of the ADC 31 is greater than or equal to 0 V and less than or equal to the power supply voltage VDD2. That is to say, the ADC 31 is able to correctly convert the input analog voltage greater than or equal to 0 V and less than or equal to power supply voltage VDD2 into the digital signal SADC. When the input analog voltage is a negative voltage or the input analog voltage exceeds the power supply voltage VDD2, the ADC 31 is unable to correctly convert the input analog voltage into the digital signal SADC. The digital value of the digital signal SADC is a value within a range from a minimum digital value to a maximum digital value, wherein the maximum digital value is greater than the minimum digital value. When the ADC 31 is a 10-bit ADC, the minimum digital value is 0 and the maximum digital value is 1023.

When the input analog voltage is within a range from 0 V to the power supply voltage VDD2, the digital value of the digital signal SADC monolithically increases from the minimum digital value toward the maximum digital value as the input analog voltage increases. When the input analog voltage is a negative voltage, the digital value of the digital signal SADC is not dependent on a size of the input analog value and is consistent with the minimum digital value. When the input analog voltage exceeds the power supply voltage VDD2, the digital value of the digital signal SADC is not dependent on a size of the input analog value and is consistent with the maximum digital value.

The arithmetic circuit 32 detects the target temperature by performing a predetermined operation process based on the digital signal SADC from the ADC 31. The arithmetic circuit 32 generates and outputs a temperature detection signal S_{DET} indicating a detection result of the target temperature. The detection of the target temperature can be understood as to have the same significance as that of the generation or output of the temperature detection signal S_{DET}. The arithmetic circuit 32 can be implemented by a logic circuit capable of performing the operation process. The temperature detection signal S_{DET} is a digital signal. The digital value of the temperature detection signal S_{DET} has a detection value indicating the target temperature. Moreover, a modification of setting the temperature detection signal S_{DET} as an analog signal can also be carried out.

The arithmetic circuit 32 receives the supply of the power supply voltage VDD2, and performs driving based on the power supply voltage VDD2. The power supply voltage VDD2 is a power supply voltage with respect to a high potential side of the arithmetic circuit 32, and a power supply voltage on the low potential side of the arithmetic circuit 32 is 0 V. Moreover, the arithmetic circuit 32 can also perform driving based on a power supply voltage different from the power supply voltage VDD2.

The reference voltage generation circuit 40 includes a diode db as a reference diode, and includes a buffer amplifier 41. The diode db is disposed at a position near the diode Da. Thus, a temperature of the diode db is substantially consistent with the target temperature. However, the temperature of the diode db can be slightly different from the target temperature. In all cases, the diode db is disposed at a position having a temperature corresponding to the target temperature, the temperature of the diode db also increases if the target temperature increases, and the temperature of the diode db also decreases if the target temperature decreases. Moreover, the diodes Da and db have the same structure as each other, and thus have the same electrical characteristics as each other. The electrical characteristics herein include a temperature characteristic.

An anode of the diode db is connected to a node NDb, and a cathode of the diode db is connected to ground. As described above, since the drain of the transistor 13 is connected to the node NDb, the reference current If0 which is the drain current of the transistor 13 flows in a forward direction of the diode db. The reference current If0 has a current value equal to that of the evaluation current If2. Moreover, the evaluation current If1 is set to be greater than the evaluation current If2. However, a modification of the evaluation current If1 less than the evaluation current If2 can also be carried out.

The denotation “Vref0” is used to reference a voltage at the node NDb. The voltage Vref0 at the node NDb is a forward voltage of the diode db when the reference current If flows in a forward direction of the diode db.

The buffer amplifier 41 receives the voltage Vref0 of the node NDb by a sufficiently high impedance, and outputs a voltage corresponding to the voltage Vref0 of the node NDb by a sufficiently low impedance. Herein, the buffer amplifier 41 is set to be a voltage follower, and thus an output voltage of the buffer amplifier 41 has a voltage value equal to that of the voltage Vref0. The output voltage of the buffer amplifier 41 is the reference voltage Vref. Moreover, as a variation, the voltage Vref0 can be amplified by an amplification factor of greater than 1 by the buffer amplifier 41, and the amplified voltage is output as the reference voltage Vref.

More specifically, the buffer amplifier 41 includes an operational amplifier. In the operational amplifier serving as the buffer amplifier 41, an inverting input terminal and an output terminal are connected to each other, and a non-inverting input terminal is connected to the node NDb and thus receives the voltage Vref0. The reference voltage Vref is output from the output terminal of the operational amplifier serving as the buffer amplifier 41, and the output terminal of the operational amplifier serving as the buffer amplifier 41 is connected to the first end of the resistor 22. The operational amplifier serving as the buffer amplifier 41 receives the supply of the power supply voltage VDD1, and performs driving based on the power supply voltage VDD1. A power supply voltage with respect to a low potential side of the buffer amplifier 41 can be 0 V.

The control circuit 50 individually controls on and off of the switches 16 and 17. Moreover, the control circuit 50 perform control of an execution timing of the AD conversion using the ADC 31. The control of the execution timing of the AD conversion includes timing control of sampling in the ADC 31. Further, the control circuit 50 performs execution control of the operation process using the arithmetic circuit 32.

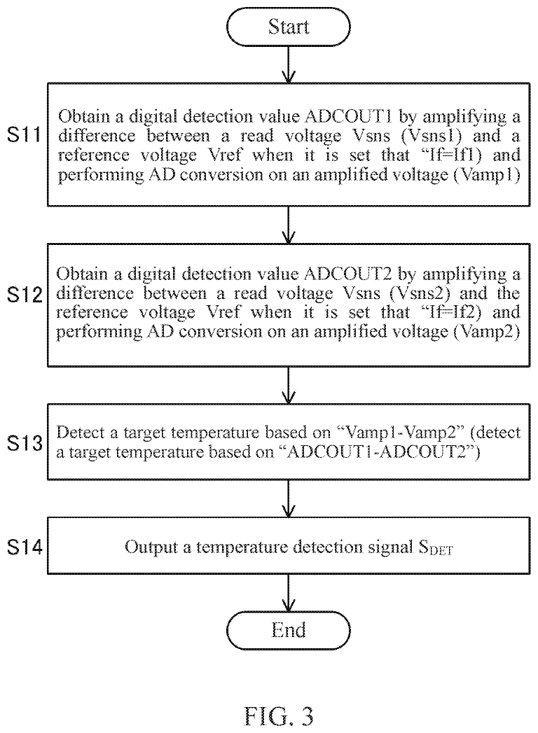

FIG. 3 shows a flowchart of an operation of the temperature sensor 1. Referring to FIG. 3, a process of the operation of the temperature sensor 1 is described below.

First of all, in step S11, the control circuit 50 sets “If=If1” by controlling the switch 16 between the switches 16 and 17 to be on. Setting “If=If1” means that the current supply circuit 10 is controlled to supply the evaluation current If1 as the forward current If of the diode Da to the diode Da.

The read voltage Vsns when it is set that “If=If1” is especially referred to as a read voltage Vsns1. In step S11, the amplified voltage Vamp when it is set that “If=If1” is output from the amplifying circuit 20. The amplified voltage Vamp when it is set that “If=If1” is an amplified voltage Vamp of a difference between the read voltage Vsns1 and the reference voltage Vref, and is to be referred to as an amplified voltage Vamp1 below. In step S11, under the control of the control circuit 50, the ADC 31 performs the AD conversion on the amplified voltage Vamp1. Accordingly, a digital detection value ADCOUT1 is obtained. That is to say, the digital signal SADC (a first digital signal) obtained from the AD conversion on the amplified voltage Vamp1 has the digital detection value ADCOUT1. The digital detection value ADCOUT1 represents a digital value of an analog voltage value of the amplified voltage Vamp1.

Next, in step S12, the control circuit 50 sets “If=If2” by controlling the switch 17 between the switches 16 and 17 to be on. Setting “If=If2” means that the current supply circuit 10 is controlled to supply the evaluation current If2 as the forward current If of the diode Da to the diode Da.

The read voltage Vsns when it is set that “If=If2” is especially referred to as a read voltage Vsns2. In step S12, the amplified voltage Vamp when it is set that “If=If2” is output from the amplifying circuit 20. The amplified voltage Vamp when it is set that “If=If2” is an amplified voltage Vamp of a difference between the read voltage Vsns2 and the reference voltage Vref, and is to be referred to as an amplified voltage Vamp2 below. In step S12, under the control of the control circuit 50, the ADC 31 performs the AD conversion on the amplified voltage Vamp2. Accordingly, a digital detection value ADCOUT2 is obtained. That is to say, the digital signal SADC (a second digital signal) obtained from the AD conversion on the amplified voltage Vamp2 has the digital detection value ADCOUT2. The digital detection value ADCOUT2 represents a digital value of an analog voltage value of the amplified voltage Vamp2.

Moreover, it is assumed that the process of step S12 is performed after step S11, but the process of step S11 can also be performed after step S12. In all cases, step S13 is performed after the processes of step S11 and step S12.

In step S13, the temperature detection circuit 30 detects the target temperature based on a difference voltage (Vamp1−Vamp2) between the amplified voltage Vamp1 and the amplified voltage Vamp2. In practice, in step S13, the arithmetic circuit 32 detects the target temperature based on the digital detection values ADCOUT1 and ADCOUT2. Then, in step S14, the arithmetic circuit 32 outputs a temperature detection signal S_{DET} indicating the detection result of the target temperature to an external circuit (not shown). The external circuit is any circuit needing the detection result of the target temperature.

Details related to the operations of steps S11 to S14 are supplemented with the use of formulae below. First of all, the read voltages Vsns1 and Vsns2 generated in steps S11 and S12 satisfy formulae (C1) and (C2) below. The right of formulae (C1) and (C2) is the same as the right of formulae (A2) and (A3) above.

$$V sns 1 = ( {K}_{B} / q ) \times {T}_{D} \times ln ( If 1 / Is ) \qquad ( C1 )$$

$$V sns 2 = ( {K}_{B} / q ) \times {T}_{D} \times ln ( If 2 / Is ) \qquad ( C2 )$$

According to a relationship (equivalent to formula (B1) above) associated with input and output voltages of the amplifying circuit 20, the amplified voltages Vamp1 and Vamp2 satisfy formulae (C3) and (C4) below.

$$V amp 1 = ( V sns 1 - V ref ) \times {A}_{F} + V ref \qquad ( C3 )$$

$$V amp 2 = ( V sns 2 - V ref ) \times {A}_{F} + V ref \qquad ( C4 )$$

As such, the difference voltage (Vamp1−Vamp2) is expressed by formula (C5) below. The difference voltage (Vamp1−Vamp2) is equal to a value of setting a voltage ΔVf shown in formula (A4) above to A_{F} times.

$$V amp 1 - V amp 2 = ( V sns 1 - V ref ) \times {A}_{F} + V ref ) - ( ( V sns 2 - V ref ) \times {A}_{F} + V ref ) = ( V sns 1 - V sns 2 ) \times {A}_{F} = ( ( {K}_{B} / q ) \times {T}_{D} \times ln ( If 1 / Is ) - ( {K}_{B} / q ) \times {T}_{D} \times ln ( If 2 / Is ) ) \times {A}_{F} = ( {K}_{B} / q ) \times {T}_{D} \times ln ( If 1 / If 2 ) ) \times {A}_{F} \qquad ( C5 )$$

For the temperature sensor 1 (the arithmetic circuit 32), the Boltzmann constant KB, an electrical charge value q of electrons, values of the evaluation currents If1 and If2, and the amplification factor A_{F} of the amplifying circuit 20 are known. Thus, according to formula (C5) the arithmetic circuit 32 can obtain the target temperature (that is, the temperature T_{D}).

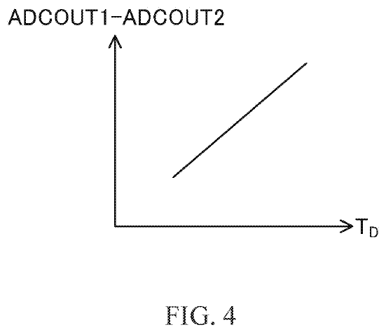

In practice, the arithmetic circuit 32 derives the difference (ADCOUT1−ADCOUT2). Since the digital detection values ADCOUT1 and ADCOUT2 represent analog voltage values of the amplified voltages Vamp1 and Vamp2, the difference voltage (Vamp1−Vamp2) is presented by a value of the difference (ADCOUT1−ADCOUT2). It is known from formula (C5) that, the difference voltage (Vamp1−Vamp2) is proportional to the temperature T_{D}, and so (ADCOUT1−ADCOUT2) is also proportional to the temperature T_{D} (referring to FIG. 4).

Thus, the arithmetic circuit 32 can cause the temperature detection signal S_{DET} to have the difference (ADCOUT1−ADCOUT2) or the difference (ADCOUT1−ADCOUT2) as a value that is K times (K>1). The target temperature (that is, the temperature T_{D}) is presented by a value of the temperature detection signal S_{DET}. The detection resolution of the target temperature can be adjusted by adjusting the amplification factor A_{F} of the amplifying circuit 20 or a current ratio (If1/If2). For example, a change of 1 in the value of the temperature detection signal S_{DET} is equivalent to a change of 0.5° C. in the temperature T_{D}, and the detection resolution at this point is 0.5° C.

In the multiple embodiments below, several specific operation examples, application techniques and variation techniques related to the temperature sensor 1 are described. Unless otherwise specified and without any contradiction, the items enumerated in this embodiment are applicable to the various embodiments examples below. In the various embodiments, the description of the embodiments can be considered as overruling in case of any items contradictory from the items described above. Provided there are not contradictions, the items described in any one of the embodiments below are also applicable to any other embodiment (that is to say, any two or more of the embodiments can be combined).

### First Embodiment

The first embodiment is described. In the first embodiment, it is assumed that the evaluation current If1 is 50 μA, the evaluation current If2 and the reference current If0 are 5 μA, the amplification factor A_{F} of the amplifying circuit 20 is 8, and the power supply voltage VDD2 is 1.5 V. At this point, the difference voltage (Vamp1−Vamp2) in formula (C5) is expressed by a formula below.

$$V amp 1 - V amp 2 = ( ( {K}_{B} / q ) \times {T}_{D} \times ln ( If 1 / If 2 ) \times {A}_{F} = ( {K}_{B} / q ) \times {T}_{D} \times ln ( 10 ) \times 8$$

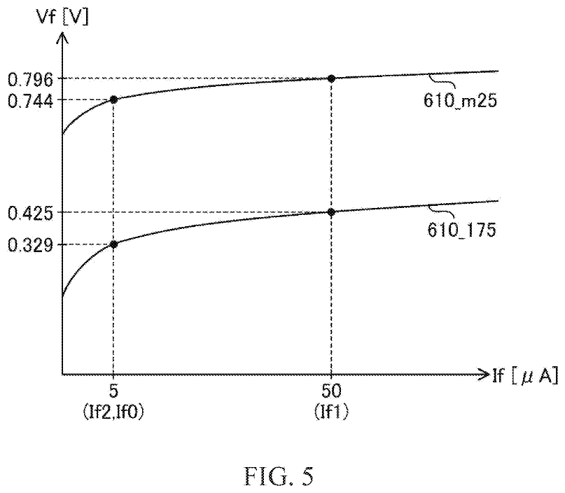

In FIG. 5, curves 610_175 and 610_m25 respectively indicate relationships between the forward current If and the forward voltage Vf of the diode Da. The curve 610_175 indicates the relationship when the temperature T_{D} is 175° C., and the curve 610_m25 indicates the relationship when the temperature T_{D} is −25° C. As described above, since the diodes Da and db are formed to have the same electrical characteristics as each other, the relationships between the forward current and the forward voltage of the diode db also follow the curves 610_175 and 610_m25 (the deviation is overlooked herein). Moreover, it is considered that the temperatures of the diodes Da and db are consistent.

When the temperature T_{D} is −25° C., the forward voltage Vf of the diode Da generated when the forward current If of 5 μA is supplied to the diode Da is 0.744 V. Similarly, when the temperature T_{D} is −25° C., the forward voltage of the diode db generated when the forward current of 5 μA is supplied to the diode db is 0.744 V.

When the temperature T_{D} is −25° C., the forward voltage Vf of the diode Da generated when the forward current If of 50 μA is supplied to the diode Da is 0.796 V. Similarly, when the temperature T_{D} is −25° C., the forward voltage of the diode db generated when the forward current of 50 μA is supplied to the diode db is 0.796 V.

When the temperature T_{D} is 175° C., the forward voltage Vf of the diode Da generated when the forward current If of 5 μA is supplied to the diode Da is 0.329 V. Similarly, when the temperature T_{D} is 175° C., the forward voltage of the diode db generated when the forward current of 5 μA is supplied to the diode db is 0.329 V.

When the temperature T_{D} is 175ºC, the forward voltage Vf of the diode Da generated when the forward current If of 50 μA is supplied to the diode Da is 0.425 V. Similarly, when the temperature T_{D} is 175° C., the forward voltage of the diode db generated when the forward current of 50 μA is supplied to the diode db is 0.425 V.

As such, when the temperature T_{D} is −25° C. and “If=If1”, the amplified voltage Vamp1 follows formula (C3), and is 1.16 V according to “Vamp1=(Vsns1−Vref)×A_{F}+Vref=(0.796-0.744)×8+0.744=1.16”.

On the other hand, when the temperature T_{D} is 175° C. and “If=If1”, the amplified voltage Vamp1 follows formula (C3), and is 1.097 V according to “Vamp1=(Vsns1−Vref)×A_{F}+Vref=(0.425−0.329)×8+0.329=1.097”.

When the temperature T_{D} is within a range between −25° C. and 175° C., the amplified voltage Vamp1 is kept with a voltage range of 1.16 V and 1.097 V, and the voltage range is kept within the input dynamic range of the ADC 31.

Moreover, when the temperature T_{D} is −25° C. and “If=If2”, the amplified voltage Vamp2 follows formula (C4), and is 0.744 V according to “Vamp2=(Vsns2−Vref)×A_{F}+Vref=(0.744-0.744)×8+0.744-0.744”.

On the other hand, when the temperature T_{D} is 175° C. and “If=If2”, the amplified voltage Vamp2 follows formula (C4), and is 0.329 V according to “Vamp2=(Vsns2−Vref)×A_{F}+Vref=(0.329-0.329)×8+0.329-0.329”.

When the temperature T_{D} is within a range between −25° C. and 175° C., the amplified voltage Vamp2 is kept with a voltage range of 0.744 V and 0.329 V, and the voltage range is kept within the input dynamic range of the ADC 31.

Herein, a virtual temperature sensor as a comparison to the temperature sensor 1 is described below. In the virtual temperature sensor, the reference voltage Vref is fixed at 0.75 V. Except for the difference that the reference voltage Vref is fixed at 0.75 V, the virtual temperature sensor has the same configuration as that of the temperature sensor 1 in FIG. 2.

In the virtual temperature sensor, when the temperature T_{D} is −25° C. and “If=If1”, the amplified voltage Vamp1 follows formula (C3), and is 1.118 V according to “Vamp1=(Vsns1−Vref)×A_{F}+Vref=(0.796-0.75)×8+0.75=1.118”.

In the virtual temperature sensor, when the temperature T_{D} is 175° C. and “If=If1”, the amplified voltage Vamp1 follows formula (C3), and is −1.850 V according to “Vamp1=(Vsns1−Vref)×A_{F}+Vref=(0.425-0.75)×8+0.75=−1.850”.

In the virtual temperature sensor, when the temperature T_{D} is within a range between −25° C. and 175° C., the amplified voltage Vamp1 is varies within a voltage range of 1.118 V and −1.850 V, and the voltage range is not kept within the input dynamic range of the ADC 31.

In the virtual temperature sensor, when the temperature T_{D} is −25° C. and “If=If2”, the amplified voltage Vamp2 follows formula (C4), and is 0.702 V according to “Vamp2=(Vsns2−Vref)×A_{F}+Vref=(0.744-0.75)×8+0.75=0.702”.

In the virtual temperature sensor, when the temperature T_{D} is 175° C. and “If=If2”, the amplified voltage Vamp2 follows formula (C4), and is −2.618 V according to “Vamp2=(Vsns2−Vref)×A_{F}+Vref=(0.329−0.75)×8+0.75=−2.618”.

In the virtual temperature sensor, when the temperature T_{D} is within a range between −25° C. and 175° C., the amplified voltage Vamp1 is varies within a voltage range of 0.702 V and −2.618 V, and the voltage range is not kept within the input dynamic range of the ADC 31.

As such, in the virtual temperature sensor, due to the changes in temperature, it is difficult to keep the input analog voltage to the ADC 31 within the input dynamic range. If the amplification factor A_{F} is decreased in the virtual temperature sensor, although the input analog voltage of the ADC 31 can be kept within the input dynamic range, the decrease in the amplification factor A_{F} however causes a decrease in the resolution of temperature detection. In contrast, in the temperature sensor 1 in FIG. 2, since the diode db that brings the same characteristics as the characteristics of diode Da with respect to temperature changes is used to generate the reference voltage Vref, the input analog voltage to the ADC 31 can be kept within the input dynamic range (that is, high-resolution temperature detection can be performed correctly) without causing a decrease in the resolution of temperature detection.

### Second Embodiment

The second embodiment is described. Basically, the diodes Da and db have the same structure as each other and the same electrical characteristics as each other. However, the structure of the diode db can also differ slightly from the structure of the diode Da, and the electrical characteristics of the diode db can also differ slightly from the electrical characteristics of the diode Da. Even if the electrical characteristics of the diode db differ slightly from the electrical characteristics of the diode Da, the same functions and effects as those of the configuration of the first embodiment can be achieved.

In numerical examples such shown in the first embodiment, the reference voltage Vref is 0.740 V instead of 0.744 V when the temperature T_{D} is −25° C., while the reference voltage Vref is 0.325 V instead of 0.329 V when the temperature T_{D} is 175° C., and the input analog voltage to the ADC 31 is also kept with the input dynamic range of the ADC 31.

### Third Embodiment

The third embodiment is described. Basically, the reference current If0 has a current value equal to that of the evaluation current If2. However, reference current If0 can also have a current value slightly different from the current value of the evaluation current If2. Even if the current value of the reference current If0 is slightly different from the current value of the If2, the same functions and effects as those of the configuration of the first embodiment can be achieved.

In numerical examples such shown in the first embodiment, even if the value of the reference current If0 deviates from only 5 μA by a current value ΔI that is not overly large, the input analog voltage to the ADC 31 is also kept within the input dynamic range of the ADC 31.

### Fourth Embodiment

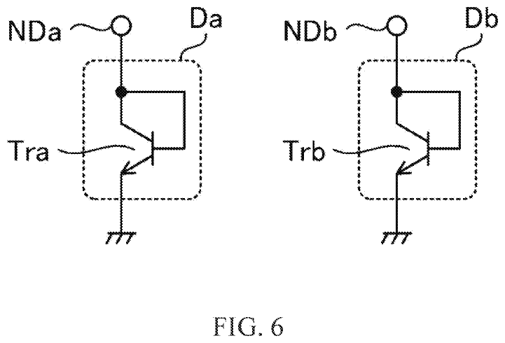

The fourth embodiment is described. The diodes Da and db can be formed by bipolar transistors. That is to say, as shown in FIG. 6, a transistor Tra which is an NPN bipolar transistor can be used as the diode Da, and a transistor Trb which is another NPN bipolar transistor can be used as a diode db. In this case, in the transistor Tra, a collector and a base are connected to each other, the collector functions as the anode of the diode Da and is connected to the node NDa, and an emitter functions as the cathode of the diode Da and is connected to ground. Similarly, in the transistor Trb, a collector and a base are connected to each other, the collector functions as the anode of the diode db and is connected to the node NDb, and an emitter functions as the cathode of the diode db and is connected to ground.

The transistors Tra and Trb have the same structure as each other, and thus have the same electrical characteristics as each other. Accordingly, the electrical characteristics of the diodes Da and db are the same as each other. However, the structure of the transistor Trb can be slightly different from the structure of the transistor Tra, and the electrical characteristics of the transistor Trb can also be slightly different from the electrical characteristics of the transistor Tra. In this case, although the electrical characteristics of the diodes Da and db are slightly different from each other, no particular issues is incurred, as described in the second embodiment.

Moreover, PNP bipolar transistors can also be used to form the diodes Da and db in substitution for the NPN bipolar transistors.

### Fifth Embodiment

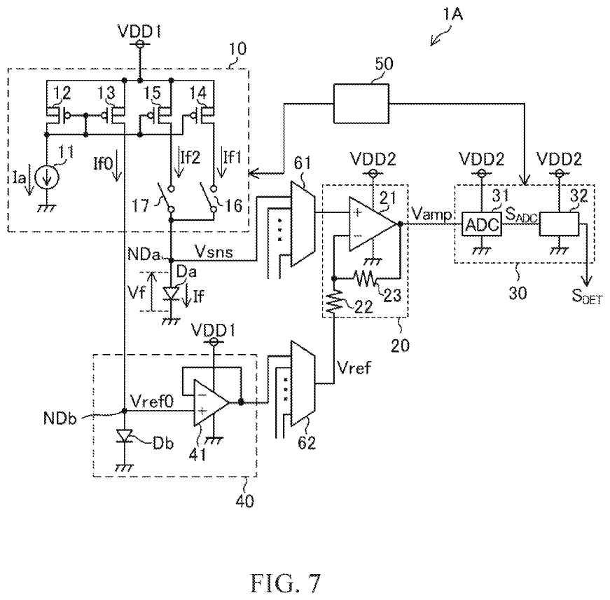

The fifth embodiment is described. FIG. 7 shows a configuration diagram of a sensor device 1A according to the fifth embodiment of the present disclosure. The sensor device 1A is formed by adding selectors 61 and 62 to the temperature sensor 1 in FIG. 2. In the sensor device 1A, a plurality of read voltages are input to the selector 61, and the selector 61 outputs any one of the multiple read voltages to the non-inverting input terminal of the operational amplifier 21 according to the control of the control circuit 50. In the sensor device 1A, a plurality of reference voltages are input to the selector 62, and the selector 62 outputs any one of the plurality of reference voltages as the reference voltage Vref to the first end of the resistor 22 according to the control of the control circuit 50.

One of the plurality of read voltages input to the selector 61 is the read voltage Vsns. One of the multiple reference voltages input to the selector 62 is the output voltage of the buffer amplifier 41. The sensor device 1A includes a temperature sensor therein. In the sensor device 1A, when the selector 61 outputs the read voltage Vsns to the non-inverting input terminal of the operational amplifier 21 and the selector 62 outputs the output voltage of the buffer amplifier 41 as the reference voltage Vref to the first end of the resistor 22, the sensor device 1A is equivalent to the temperature sensor 1 in FIG. 2. Thus, it can be considered that the sensor device 1A includes the temperature sensor 1 therein.

In the sensor device 1A, by using the selectors 61 and 62, the amplification function of the amplifying circuit 20 for the difference voltage between the voltages Vsns and Vref0 can be used for a different purpose, and the digitalizing function of the ADC 31 to the difference voltage between the voltages Vsns and Vref0 can also be used for a different purpose.

### Sixth Embodiment

The sixth embodiment is described.

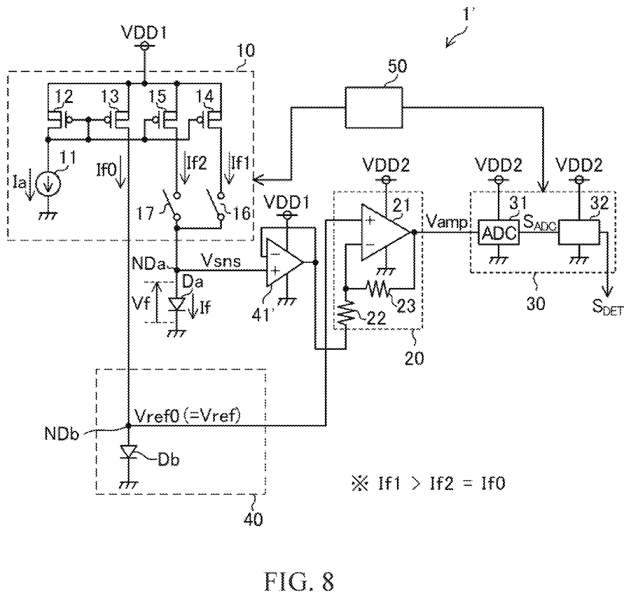

In the temperature sensor 1, a variation in which the read voltage Vsns is supplied to the side of the inverting input terminal of the operational amplifier 21 and the reference voltage Vref is supplied to the side of the inverting input terminal of the operational amplifier 21 can be implemented. FIG. 8 shows a configuration diagram of a temperature sensor 1′ as the variation implemented based on the temperature sensor 1. In the temperature sensor 1′, the buffer amplifier 41 is removed from the reference voltage generation circuit 40 in FIG. 2, and the voltage Vref0 of the node NDb is directly supplied as the reference voltage Vref to the non-inverting input terminal of the operational amplifier 21. Moreover, in the temperature sensor 1′, the read voltage Vsns of the node NDa is supplied to the first end of the resistor 22 via a buffer amplifier 41′, and the second end of the resistor 22 is connected to the inverting input terminal of the operational amplifier 21. Except for the difference above, the temperature sensor 1′ in FIG. 8 is the same as the temperature sensor 1 in FIG. 2. The buffer amplifier 41′ is a voltage follower having an equivalent structure as the buffer amplifier 41 in FIG. 2. More specifically, the buffer amplifier 41′ includes an operational amplifier. In the operational amplifier serving as the buffer amplifier 41, an inverting input terminal and an output terminal are connected to each other, and a non-inverting input terminal is connected to the node NDa and thus receives the read voltage Vsns. A voltage (having a voltage with a voltage value substantially the same as that of the read voltage Vsns) corresponding to the read voltage Vsns is output from the output terminal of the operational amplifier serving as the buffer amplifier 41′ to the first end of the resistor 22. The read voltage Vsns of the node NDa is impedance converted at the buffer amplifier 41′ and supplied to the first end of the resistor 22.

In the description above, a configuration in which the potentials of the cathodes of the diodes Da and db are consistent with the ground potential is described; however, the potentials of the cathodes of the diodes Da and db can also be different from the ground potential.

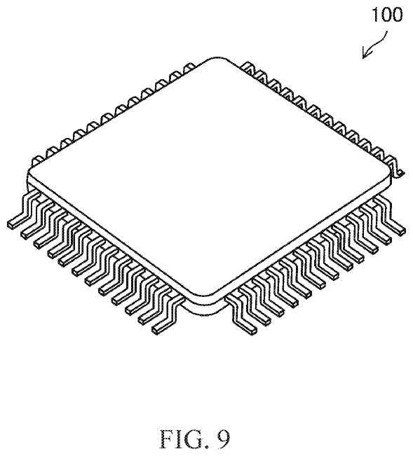

The temperature sensor 1 or the sensor device 1A can be assembled in any semiconductor device as desired. FIG. 9 shows a perspective diagram of an appearance of a semiconductor device 100 assembled with the temperature sensor 1 or the sensor device 1A. The semiconductor device 100 is an electronic component including a semiconductor chip having a semiconductor integrated circuit formed on a semiconductor substrate, a housing (a package) accommodating the semiconductor chip, and a plurality of external terminals exposed from the housing to the outside of the semiconductor device 100. The semiconductor device 100 is formed by packaging the semiconductor integrated in the housing (the package) formed of a resin. Moreover, the number of the external terminals of the semiconductor device 100 and the type of the housing of the semiconductor device 100 shown in FIG. 9 are merely examples, and can be designed as desired. The semiconductor integrated circuit in the semiconductor device 100 further includes various functional circuits in addition to including the temperature sensor 1 or the sensor device 1A. The functional circuits are, for example, DC/DC converts and motor drivers.

The position of the temperature to be detected is referred to as a target position. The target temperature is a temperature of the target position. Any position (for example, a central position) of the semiconductor device 100 is set as the target position. In the semiconductor device 100, a plurality of positions can also be set as target positions. In this case, the temperature sensor 1 can be disposed according to each of the target positions. A set of the diodes Da and db can also be disposed according to each of the target positions. On the other hand, by commonly assigning a detection block including the amplifying circuit 20 and the temperature detection circuit 30 to multiple sets of diodes Da and db and switching an input signal to the amplifying circuit 20 by the selectors 61 and 62, one single detection block can be used for detection for a plurality of target temperatures.

The types of the channels of the field-effect transistors (FETs) shown in the embodiments are examples. Without compromising the form of the subject, any variation between P-type channels and N-type channels can be made.

Given that no issues are incurred, any transistor may also be any type of transistor. For example, given that no issues are incurred, any transistor implemented by a MOSFET may be replaced by a junction FET or a bipolar transistor.

Various modifications may be appropriately made to the embodiments of the present disclosure within the scope of the technical concept of the claims. The embodiments above are only examples of possible implementations of the present disclosure, and the meanings of the terms of the present disclosure or the constituents are not limited to the meanings of the terms used in the embodiments above. The specific numerical values used in the description are only examples, and these numerical values may be modified to various other numerical values.

### <<Notes>>

A note is attached to the present disclosure to show specific configuration examples of the embodiments above.

A temperature sensor (1) according to an aspect of the present disclosure is configured as (a first configuration), comprising:
a temperature detection diode (Da), disposed at a position having a target temperature;
a current supply circuit (10), configured to supply a first evaluation current (If1) and a second evaluation current (If2) to the temperature detection diode in a forward direction of the temperature detection diode at different timings;
an amplifying circuit (20), configured to
   generate a first amplified voltage (Vamp1) by amplifying a difference between a forward voltage of the temperature detection diode and a reference voltage (Vref) during a supply period of a first evaluation current to the temperature detection diode, and
   generate a second amplified voltage (Vamp2) by amplifying the difference between the forward voltage of the temperature detection diode and the reference voltage during a supply period of the second evaluation current to the temperature detection diode;
a temperature detection circuit (30), configured to detect the target temperature based on the first amplified voltage and the second amplified voltage; and
a reference voltage generation circuit (40), configured to
   include a reference diode (db) disposed at a position having a temperature corresponding to the target temperature, and
   generate the reference voltage using a forward voltage of the reference diode when a reference current (If0) is supplied in a forward direction of the reference diode.

In a situation where it is assumed that a fixed voltage is used for the reference voltage, there is a concern that an amplified voltage with respect to temperature changes exceeds an input dynamic range of the temperature detection circuit. If the amplification factor is decreased, the concern can be eliminated; however, the decrease in the amplification factor causes a decrease in the resolution of temperature detection. Considering the above, in the temperature sensor of the first configuration, the reference diode that brings the same characteristics as the characteristics of the temperature detection diode with respect to temperature changes is used to generate the reference voltage. Accordingly, without causing a decrease in the resolution of temperature detection, the amplified voltage can be kept within the input dynamic range of the temperature detection circuit.

The temperature sensor of the first configuration can also be configured as (a second configuration), wherein the first evaluation current and the second evaluation current have current values different from each other, and the temperature detection circuit is configured to detect the target temperature based on a difference between the first amplified voltage and the second amplified voltage.

The temperature sensor of the second configuration can also be configured as (a third configuration), wherein the temperature detection circuit includes:
an AD converter (31), configured to receive the first amplified voltage and the second amplified voltage from the amplifying circuit as input analog voltages, and convert the first amplified voltage and the second amplified voltage into a first digital signal and a second digital signal, respectively; and
an arithmetic circuit (32), configured to detect the target temperature based on a difference (ADCOUT1−ADCOUT2) between the first digital signal and the second digital signal.

If an input analog voltage exceeds an input dynamic range of the AD converter, temperature detection cannot be performed correctly. In the temperature sensor of the third configuration, the reference diode that brings the same characteristics as the characteristics of the temperature detection diode with respect to temperature changes is used to generate the reference voltage. Accordingly, without causing a decrease in the resolution of temperature detection, the input analog voltage can be kept within the input dynamic range of the AD converter (that is, high-resolution temperature detection can be performed correctly).

The temperature sensor of any one of the first to third configurations can also be configured as (a fourth configuration), wherein the current supply circuit is configured to supply a current having same current value as the second evaluation current to the reference diode as the reference current.

The temperature sensor of any one of the first to fourth configurations can also be configured as (a fifth configuration), wherein the temperature detection circuit is configured to generate a temperature detection signal indicating a detection result of the target temperature.

The temperature sensor of any one of the first to fifth configurations can also be configured as (a sixth configuration), wherein each of the temperature detection diode and the reference diode is formed by a bipolar transistor having a collector and a base connected to the collector.

1. A temperature sensor, comprising:
a temperature detection diode, disposed at a position having a target temperature;
a current supply circuit, configured to supply a first evaluation current and a second evaluation current to the temperature detection diode in a forward direction of the temperature detection diode at different timings;
an amplifying circuit, configured to
generate a first amplified voltage by amplifying a difference between a forward voltage of the temperature detection diode and a reference voltage during a supply period of a first evaluation current to the temperature detection diode, and
generate a second amplified voltage by amplifying the difference between the forward voltage of the temperature detection diode and the reference voltage during a supply period of the second evaluation current to the temperature detection diode;
a temperature detection circuit, configured to detect the target temperature based on the first amplified voltage and the second amplified voltage; and
a reference voltage generation circuit, configured to
include a reference diode disposed at a position having a temperature corresponding to the target temperature, and
generate the reference voltage using a forward voltage of the reference diode when a reference current is supplied in a forward direction of the reference diode.

2. The temperature sensor of claim 1, wherein
the first evaluation current and the second evaluation current have current values different from each other, and
the temperature detection circuit is configured to detect the target temperature based on a difference between the first amplified voltage and the second amplified voltage.

3. The temperature sensor of claim 2, wherein the temperature detection circuit includes:
an AD converter, configured to
receive the first amplified voltage and the second amplified voltage from the amplifying circuit as input analog voltages, and
convert the first amplified voltage and the second amplified voltage into a first digital signal and a second digital signal, respectively; and
an arithmetic circuit, configured to detect the target temperature based on a difference between the first digital signal and the second digital signal.

4. The temperature sensor of claim 1, wherein the current supply circuit is configured to supply a current having same current value as the second evaluation current to the reference diode as the reference current.

5. The temperature sensor of claim 2, wherein the current supply circuit is configured to supply a current having same current value as the second evaluation current to the reference diode as the reference current.

6. The temperature sensor of claim 3, wherein the current supply circuit is configured to supply a current having same current value as the second evaluation current to the reference diode as the reference current.

7. The temperature sensor of claim 1, wherein the temperature detection circuit is configured to generate a temperature detection signal indicating a detection result of the target temperature.

8. The temperature sensor of claim 2, wherein the temperature detection circuit is configured to generate a temperature detection signal indicating a detection result of the target temperature.

9. The temperature sensor of claim 3, wherein the temperature detection circuit is configured to generate a temperature detection signal indicating a detection result of the target temperature.

10. The temperature sensor of claim 1, wherein each of the temperature detection diode and the reference diode is formed by a bipolar transistor having a collector and a base connected to the collector.

11. The temperature sensor of claim 2, wherein each of the temperature detection diode and the reference diode is formed by a bipolar transistor having a collector and a base connected to the collector.

12. The temperature sensor of claim 3, wherein each of the temperature detection diode and the reference diode is formed by a bipolar transistor having a collector and a base connected to the collector.
